(19) United States
(12) Patent Application Publication
(10) Pub. No.: US 2019/0099865 A1
(43) Pub. Date: Apr. 4, 2019

(54) RATCHET WRENCH

(71) Applicant: Yu-Hua OU, Taichung City (TW)

(72) Inventor: Yu-Hua OU, Taichung City (TW)

(21) Appl. No.: 15/723,593

(22) Filed: Oct. 3, 2017

(51) Int. Cl. B25B 13/46

(52) U.S. Cl. CPC B25B 13/463

(57) ABSTRACT

The ratchet wrench has a switching button including a switching portion outside and a control portion in the wrench. The top face of the control portion is formed with an insertion groove, and a T-shaped restriction element is inserted into the insertion groove with an end. The restriction element prevents the switching button from falling. When the switching button is rotated, two sides of the restriction element selectively abut against the inner wall of the wrench to restrict the rotation range of the switching button.

### BACKGROUND OF THE INVENTION

### Field of the Invention

The present invention relates to a ratchet wrench.

### Description of the Prior Art

The switching button of the conventional ratchet wrench is placed into the wrench from a side of the wrench and is positioned by a positioning element from another side of the wrench to prevent the switching button from falling. Thus, it is difficult to assemble, and various elements have to be prepared. Besides, when toggling, the toggle element for switching the toothed element always hits the wrench to make the toggle element abrade. In addition, the toggle element is usually short because of the toothed element, so the toggle element is possible to be jammed in the receiving space where the switching button is received.

In the patent TW 587509, the receiving space is designed closed, and a blocking plate is used to block the switching button. However, the toggle element still hits the inner wall of the wrench, and the toggle element is still abraded.

In the patent TW M282787, the toggle element plays a role of the blocking plate. However, the toggle element still hits the inner wall of the wrench. Thus, the abrasion is inevitable.

### SUMMARY OF THE INVENTION

The main object of the present invention is to provide a ratchet wrench which is easy to manufacture and assemble. In addition, the toggle element is prevented from abrasion.

To achieve the above and other objects, the ratchet wrench of the present invention includes a main body, a ratchet head, a toothed element, a switching button, a toggle element, a first elastic element, a positioning element, a second elastic element, and a restriction element.

The main body includes a tool head and a grip. The tool head has a first receiving recess, a second receiving recess, and a third receiving recess which are arranged in sequence and communicate with each other. The ratchet head is rotatably received in the first receiving recess. The ratchet head includes an annular toothed face and an operation portion. The toothed element is received in the second receiving recess and is movable between a first position and a second position. The toothed element has a toothed portion at an end thereof near the first receiving recess. The toothed element has a switching recess at an end thereof near the third receiving recess. The toothed portion is engaged with the annular toothed face. The switching button includes a switching portion and a control portion. The control portion is rotatably inserted in the third receiving recess. The switching portion is located outside the main body. The switching portion is adapted for toggling to make the control portion rotate. The control portion is formed with two positioning recesses at an end thereof away from the toothed element. The control portion is formed with an insertion groove at an end thereof near the toothed element. The toggle element is connected to the control portion via a first elastic element. An end of the toggle element away from the switching button extends into the switching recess. The positioning element is received in the third receiving recess at an end of the third receiving recess away from the second receiving recess. The positioning element tends to move toward the switching button by the second elastic element. The positioning element selectively abuts against one of the two positioning recesses. The restriction element is substantially T-shaped to have a wider restriction portion and a narrower insertion portion. The insertion portion is inserted into the insertion groove. When the switching button is rotated, two sides of the restriction portion selectively abut against lateral walls of the main body between the second receiving recess and the third receiving recess so as to restrict a rotation range of the switching button. Thereby, the toggle element switches the toothed element between the first position and the second position by rotating the switching button.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 2A is a front view showing a restriction element of the present invention;

FIG. 3 is a cross-section of the present invention;

FIG. 4 is a partial cross-section of the present invention.

### DETAILED DESCRIPTION OF THE PREFERRED EMBODIMENTS

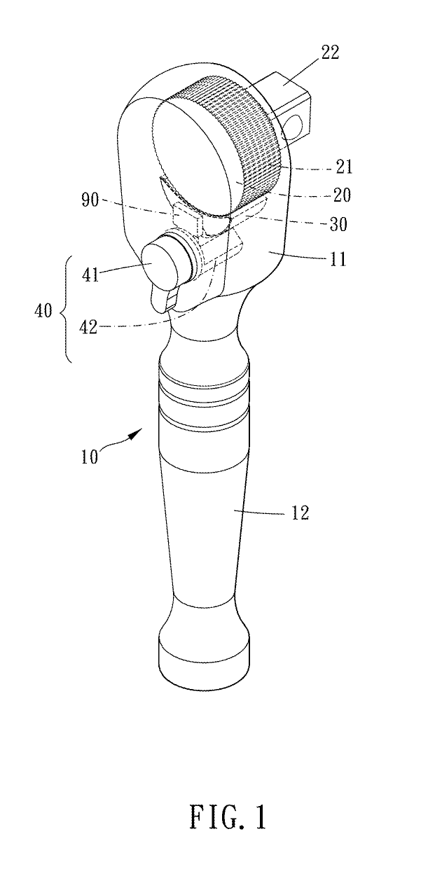

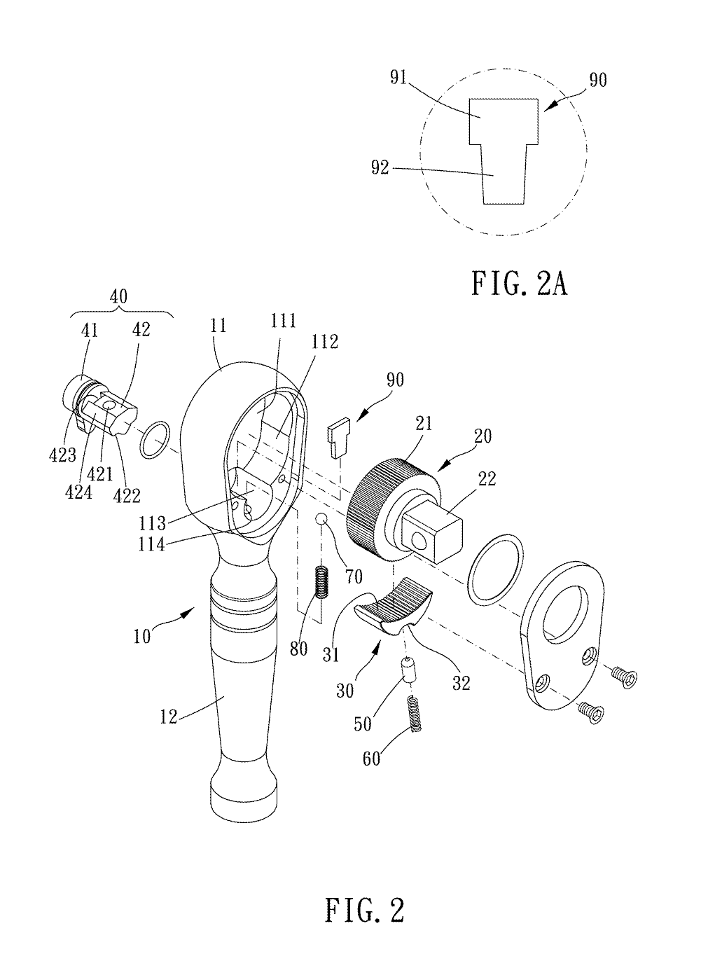

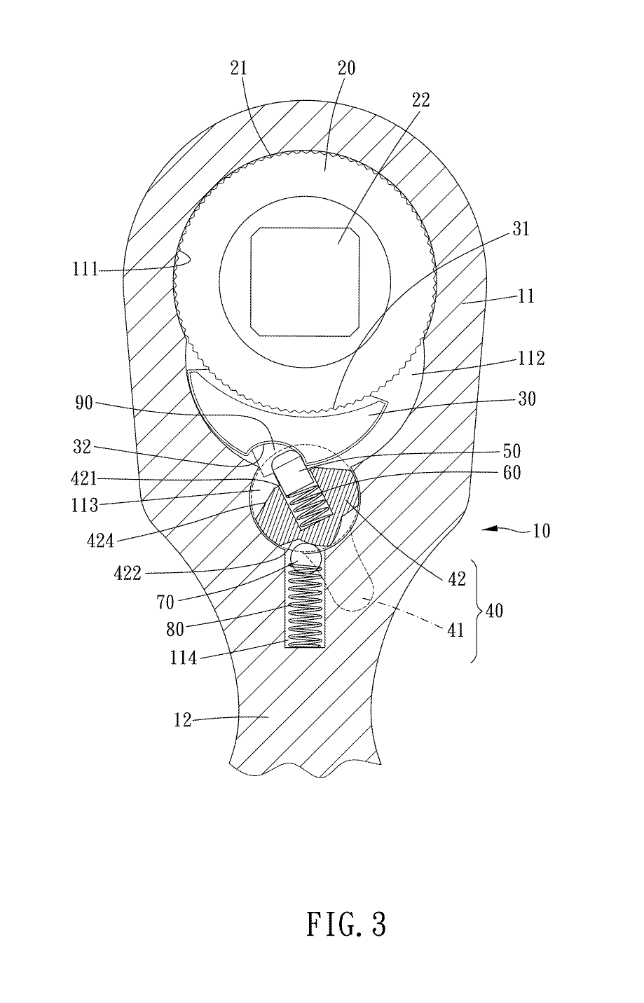

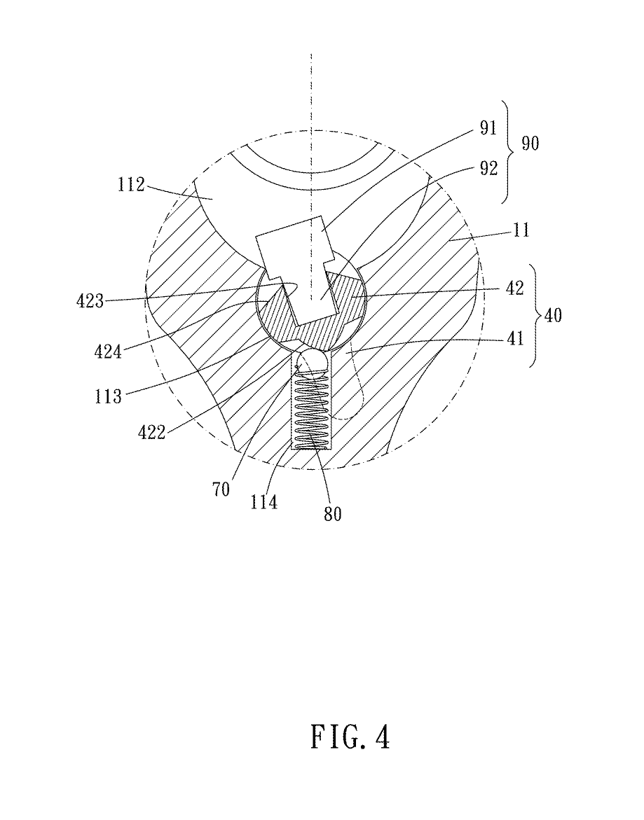

Please refer to FIG. 1 to FIG. 4 and FIG. 2A, the ratchet wrench of the present invention includes a main body 10, a ratchet head 20, a toothed element 30, a switching button 40, a toggle element 50, a first elastic element 60, a positioning element 70, a second elastic element 80, and a restriction element 90.

The main body 10 includes a tool head 11 and a grip 12. The tool head 11 has a first receiving recess 111, a second receiving recess 112, and a third receiving recess 113 which are arranged in sequence and communicate with each other. Specifically, the tool head 11 and the grip 12 are formed in a single piece. The first receiving recess 111, the second recess 112, and the third receiving recess 113 are aligned toward the grip 12. The first receiving recess 111 is circular, and the second receiving recess 112 is crescent. The third receiving recess 113 is circular so that the third receiving recess 113 partially overlaps the second receiving recess 112. Bottoms of the first receiving recess 111 and the second receiving recess 112 are closed, and tops thereof are open. The bottom and the top of the third receiving recess 113 are both open. Besides, the third receiving recess 113 is formed with a second receiving hole 113 on a lateral wall thereof at an end away from the second receiving recess 112 (or the toothed element 30).

The ratchet head 20 is rotatably received in the first receiving recess 111. The ratchet head 20 includes an annular toothed face 21 and an operation portion 22. Specifically, the ratchet head 20 is placed into the first receiving recess 111 via the top of the first receiving recess 111. The operation portion 22 can be a polygon or polygonal hole to connect to other tools.

The toothed element 30 is received in the second receiving recess 112 and is movable between a first position and a second position. The toothed element 30 has a toothed portion 31 at an end thereof near the first receiving recess 111. The toothed element 30 has a switching recess 32 at an end thereof near the third receiving recess 113. The toothed portion 30 is engaged with the annular toothed face 21. Specifically, the toothed element 30 is placed into the second receiving recess 112 via the top of the second receiving recess 112. The toothed element 30 is arc-shaped and is movable between two ends of the second receiving recess 112.

The switching button 40 includes a switching portion 41 and a control portion 42. The control portion 42 is rotatably inserted in the third receiving recess 113. The switching portion 41 is located outside the main body 10. The switching portion 41 is adapted for toggling to make the control portion rotate 42. The control portion 42 is formed with two positioning recesses 422 at an end thereof away from the toothed element 30. The control portion 42 is formed with an insertion groove 423 at an end thereof near the toothed element 30. The restriction element 90 is substantially T-shaped to have a wider restriction portion 91 and a narrower insertion portion 92. The insertion portion 92 is inserted into the insertion groove 423. When the switching button 40 is rotated, two sides of the restriction portion 91 selectively abut against lateral walls of the main body 10 between the second receiving recess 112 and the third receiving recess 113 so as to restrict a rotation range of the switching button 40. Specifically, the width of the insertion portion 92 is reduced from an end near the restriction portion 91 toward an end away from the restriction portion 91. The control portion 42 is placed into the third receiving recess 113 via the bottom of the third receiving recess 113 and then the restriction element 90 is inserted into the insertion groove 423 by force fit to prevent the switching button 40 from falling. A cover plate covers the tops of the first receiving recess 111, the second receiving recess 112, and the third receiving recess 113. Besides, the control portion 42 has a top face at the end of the control portion facing the toothed element. Two inclined faces 424 are formed at two sides of the top face. The two inclined faces 424 incline away from the top face. Preferably, an angle between each inclined face 424 and the top face in the control portion 42 is ranged between 140-145 degrees. Besides, the switching button 40 is formed with a first receiving hole 421 at a side facing the toothed element 30. The insertion groove 423 is located between the switching portion 41 and the first receiving hole 421.

The toggle element 50 is connected to the control portion 42 via a first elastic element 60. An end of the toggle element 50 away from the switching button 40 extends into the switching recess 32. Preferably, the first elastic element 60 and the toggle element 50 are received in the first receiving hole 421 so that the toggle element 50 tends to move toward the switching recesses 32. Besides, the toggle element 50 is preferably cylinder-shaped, and the diameter of the free end of the toggle element 50 is reduced to form a chamfer.

The positioning element 70 is received in the third receiving recess 113 at an end of the third receiving recess 113 away from the second receiving recess 112. The positioning element 70 tends to move toward the switching button 40 by the second elastic element 80. The positioning element 70 selectively abuts against one of the two positioning recesses 422. Preferably, the second elastic element 80 and the positioning element 70 are received in the second receiving hole 114. The positioning element 70 is preferably a rolling ball.

In the present embodiment, a first axis is defined by the restriction element 90 and the operation portion 22 of the ratchet head 20, and a second axis is defined by a central axis of the toggle element 50. When restriction portion 91 abuts against lateral walls of the main body 10 between the second receiving recess 112 and the third receiving recess 113, an angle between the first axis and the second axis is ranged between 25 to 30 degrees.

Thereby, the toggle element 50 switches the toothed element 30 between the first position and the second position by rotating the switching button 40.

In use, the user can toggle the switching portion to change the rotation direction of the ratchet head. Because the restriction element also moves with the switching button, the switching button may rotate smoothly. In addition, when the switching button rotates, the restriction element, instead of the toggle element, hits the lateral walls of the receiving recess. Thus, the toggle element may not be abraded or be jammed. Besides, the rotation range of the switching button can be alternated by changing the size or shape of the restriction element.

What is claimed is:

1. A ratchet wrench, including:
a main body, including a tool head and a grip, the tool head having a first receiving recess, a second receiving recess, and a third receiving recess which are arranged in sequence and communicate with each other;
a ratchet head, rotatably received in the first receiving recess, the ratchet head including an annular toothed face and an operation portion;
a toothed element, received in the second receiving recess and movable between a first position and a second position, the toothed element having a toothed portion at an end thereof near the first receiving recess, the toothed element having a switching recess at an end thereof near the third receiving recess, the toothed portion being engaged with the annular toothed face;
a switching button, including a switching portion and a control portion, the control portion being rotatably inserted in the third receiving recess, the switching portion being located outside the main body, the switching portion being adapted for toggling to make the control portion rotate, the control portion being formed with two positioning recesses at an end thereof away from the toothed element, the control portion being formed with an insertion groove at an end thereof near the toothed element;
a toggle element and a first elastic element, the toggle element being connected to the control portion via a first elastic element, an end of the toggle element away from the switching button extending into the switching recess;
a positioning element and a second elastic element, the positioning element being received in the third receiving recess at an end of the third receiving recess away from the second receiving recess, the positioning element tending to move toward the switching button by the second elastic element, the positioning element selectively abutting against one of the two positioning recesses;
a restriction element, the restriction element being substantially T-shaped to have a wider restriction portion and a narrower insertion portion, the insertion portion being inserted into the insertion groove, when the switching button is rotated, two sides of the restriction portion selectively abut against lateral walls of the main body between the second receiving recess and the third receiving recess so as to restrict a rotation range of the switching button;
wherein the toggle element switches the toothed element between the first position and the second position by rotating the switching button.

2. The ratchet wrench of claim 1, wherein the control portion has a top face at the end of the control portion facing the toothed element, two inclined faces are formed at two sides of the top face, the two inclined faces incline away from the top face.

3. The ratchet wrench of claim 2, wherein an angle between each inclined face and the top face in the control portion is ranged between 140-145 degrees.

4. The ratchet wrench of claim 1, wherein the switching button is formed with a first receiving hole at an end thereof facing the toothed element, the first elastic element and the toggle element is received in the first receiving hole.

5. The ratchet wrench of claim 4, wherein the insertion groove is located between the switching portion and the first receiving hole.

6. The ratchet wrench of claim 1, wherein a width of the insertion portion is reduced from an end thereof near the restriction portion to an end thereof away from the restriction portion, the insertion portion is positioned in the insertion groove by force fit.

7. The ratchet wrench of claim 1, wherein the third receiving recess is formed with a second receiving hole at a lateral wall away from the second receiving recess, the second elastic element and the positioning element is received in the second receiving hole.

8. The ratchet wrench of claim 1, wherein bottoms of the first receiving recess and the second receiving recess are closed, the ratchet head and the toothed element are placed into the first receiving recess and the second receiving recess via tops of the first receiving recess and the second receiving recess, the third receiving recess is open, the control portion is placed into the third receiving recess via the bottom of the third receiving recess and then the restriction element is inserted into the insertion groove to prevent the switching button from falling, a cover plate covers the tops of the first receiving recess, the second receiving recess, and the third receiving recess.

9. The ratchet wrench of claim 1, wherein a first axis is defined by the restriction element and the operation portion of the ratchet head, a second axis is defined by a central axis of the toggle element, when restriction portion abuts against lateral walls of the main body between the second receiving recess and the third receiving recess, an angle between the first axis and the second axis is ranged between 25 to 30 degrees.

10. The ratchet wrench of claim 1, wherein the toothed element is arc-shaped.

11. The ratchet wrench of claim 1, wherein the toggle element is cylinder-shaped.

12. The ratchet wrench of claim 1, wherein the positioning element is a rolling ball.
